(19) United States
(12) Patent Application Publication
(10) Pub. No.: US 2005/0065878 A1
(43) Pub. Date: Mar. 24, 2005

(54) Method and system for effecting payment for goods and/or services

(76) Inventor: Giampietro Trolio, Subiaco (AU)

Correspondence Address: ALTERA LAW GROUP, LLC, 6500 CITY WEST PARKWAY, SUITE 100, MINNEAPOLIS, MN, 55344-7704, US

(21) Appl. No.: 10/493,292

(22) PCT Filed: Oct. 23, 2002
(86) PCT No.: PCT/AU02/01436

(30) Foreign Application Priority Data
Oct. 23, 2001 (AU) PR 8426
Jan. 29, 2002 (AU) PS 0179

(51) Int. Cl. G06F 17/60

(52) U.S. Cl. 705/40

(57) ABSTRACT

A client-driven method of effecting payment for goods and/or services to be performed by a single entity, the method comprising the steps of: agreeing with a supplier terms of supply for the supply of goods and/or services; receiving details of an order for goods and/or services from a first purchaser placed with the supplier; receiving details of an order for goods and/or services from a second purchaser placed with the supplier; drawing on a credit facility of the first purchaser and a credit facility of the second purchaser; and paying the supplier for supplying the goods and/or services ordered by the first purchaser and second purchaser in accordance with the terms of supply using money drawn from the respective credit facilities of the first purchaser and second purchaser.

### FIELD OF THE INVENTION

The present invention relates to a client-driven method and system for effecting payment for goods and/or services. More particularly, the client-driven method and system is capable of managing payment for goods and/or services provided by multiple suppliers to multiple purchasers.

### BACKGROUND ART

Cash flow management is an issue in most businesses, particularly small businesses. Whilst suppliers of goods and services commonly offer discounts for prompt payment, and/or large orders, taking advantage of these offers requires monitoring of deadlines and anticipation of requirements in advance. Accordingly, few businesses, particularly small businesses, are in a position to take advantage of such offers. In addition to organisational issues, many small businesses simply do not have funds readily available to take advantage of such offers made by suppliers.

One potential solution to cash flow difficulties is the use of a credit facility and many credit facilities, particularly credit cards such as those offered under the trade marks AMERICAN EXPRESS, VISA, MASTERCARD or DINERS CLUB, have associated therewith incentive schemes designed to encourage the use of such. These incentive schemes commonly take the form of interest free periods and/or reward points that may later be traded for goods and services of value. However, inefficient use of credit facilities can be costly so many businesses are wary of using such and do not receive the full benefit of the incentive schemes.

Cash flow difficulties are equally important from the perspective of the supply of goods and/or services. Considerable supplier resources are commonly consumed in chasing up a large number of relatively small debts.

It is one object of the present invention to provide a customer-driven payment method capable of at least substantially overcoming the aforementioned problems.

Throughout the specification, unless the context requires otherwise, the word “comprise” or variations such as “comprises” or “comprising”, will be understood to imply the inclusion of a stated integer or group of integers but not the exclusion of any other integer or group of integers.

The preceding discussion of the background to the invention is intended to facilitate an understanding of the present invention. However, it should be appreciated that the discussion is not an acknowledgement or admission that any of the material referred to was part of the common general knowledge in Australia as at the priority date of the application.

### DISCLOSURE OF THE INVENTION

In accordance with a first aspect of the invention there is provided a client-driven method of effecting payment for goods and/or services to be performed by a single entity, the method comprising the steps of:
agreeing with a supplier terms of supply for the supply of goods and/or services;
receiving details of an order for goods and/or services from a first purchaser placed with the supplier;
receiving details of an order for goods and/or services from a second purchaser placed with the supplier;
drawing on a credit facility of the first purchaser and a credit facility of the second purchaser; and
paying the supplier for supplying the goods and/or services ordered by the first purchaser and second purchaser in accordance with the terms of supply using money drawn from the respective credit facilities of the first purchaser and second purchaser.

Preferably, the method includes the step of agreeing with the supplier the terms of supply includes agreeing with the supplier on a discount and/or rebate for payment of the invoice within a predetermined period.

More preferably, the predetermined period is 7 days.

Preferably, the amount drawn from the credit facility of the first purchaser is equal to the amount of the order placed by the first purchaser and a predetermined fee for facilitating payment; and/or the amount drawn from the credit facility of the second purchaser is equal to the amount of the order placed by the second purchaser and the predetermined fee for facilitating payment.

Preferably, the method further comprises the steps of:
accepting an authorisation from the first purchaser to draw on a credit facility of the first purchaser on behalf of the first purchaser; and/or
accepting an authorisation from the second purchaser to draw on a credit facility of the second purchaser on behalf of the second purchaser.

Preferably, the method includes the further step of consolidating the funds drawn from the credit facility of the first purchaser and the credit facility of the second purchaser.

Preferably, the method also includes the steps of:
issuing a rebate to the first purchaser, the rebate equating to a predetermined portion of the total of any discount and/or rebate offered by the supplier as part of the terms of supply; and/or
issuing a rebate to the second purchaser, the rebate equating to a predetermined portion of the total of any discount and/or rebate offered by the supplier as part of the terms of supply.

Preferably, the method also includes the steps of:
receiving from the first purchaser and/or second purchaser a credit statement;
recording the date by which a payment on the credit facility must be made as indicated by the credit statement; and
reminding the first purchaser and/or second purchaser, as appropriate, of the need to make such a payment, prior to the date by which payment on the credit facility must be made

More preferably, the method includes the step of reconciling entries recorded on the credit statement against payments made on behalf of the first and/or second purchaser, as appropriate.

Preferably, the credit facility of the first purchaser and/or the credit facility of the second purchaser is a credit card facility.

More preferably, the credit card facility has an interest free period and/or loyalty scheme associated therewith.

In accordance with a second aspect of the present invention there is provided a system of managing payment for goods and/or services comprising:
a first purchaser using a first purchasing computer in data communication with a facilitator computer;
a second purchaser using a second purchasing computer in data communication with the facilitator computer; and
a supplier using a supplier computer in data communication with the facilitator computer;
   wherein the facilitator computer:
agrees with the supplier computer as to the terms of supply for the supply of goods and/or services;
receives details of an order placed with the supplier for goods and/or services sent by the first purchasing computer;
receives details of an order placed with the supplier for goods and/or services sent by the second purchasing computer;
draws on a credit facility of the first purchaser and a credit facility of the second purchaser; and
pays the supplier for supplying the goods and/or services ordered by the first purchaser and second purchaser in accordance with the terms of supply using money drawn from the respective credit facilities of the first purchaser and second purchaser.

Preferably, in agreeing with the supplier computer as to the terms of supply, the facilitator computer agrees with the supplier computer on a discount and/or rebate for payment of the invoice within a predetermined period.

More preferably, the predetermined period is 7 days.

Preferably, the facilitator computer also:
draws from the credit facility of the first purchaser an amount equal to that of the order placed by the first purchaser and a predetermined fee for facilitating payment; and/or
draws from the credit facility of the second purchaser an amount equal to that of the order placed by the second purchaser and the predetermined fee for facilitating payment.

Preferably, the facilitator computer also:
accepts an authorisation from the first purchaser, through the first purchasing computer, to draw on a credit facility of the first purchaser on behalf of the first purchaser; and/or
accepts an authorisation from the second purchaser, through the second purchasing computer, to draw on a credit facility of the second purchaser on behalf of the second purchaser.

Preferably, the facilitator computer consolidates funds drawn from the credit facility of the first purchaser and the credit facility of the second purchaser.

Preferably, the facilitator computer:
issues a rebate to the first purchaser, the rebate equating to a predetermined portion of the total of any discount and/or rebate offered by the supplier as part of the terms of supply; and/or
issuing a rebate to the second purchaser, the rebate-equating to a predetermined portion of the total of any discount and/or rebate offered by the supplier as part of the terms of supply.

Preferably, the facilitator computer
receives from the first purchaser and/or second purchaser, through their respective purchasing computer, an electronic copy of a credit statement;
records the date by which a payment on the credit facility must be made as indicated by the credit statement; and
reminds the first purchaser and/or second purchaser, as appropriate and through their purchasing computer, of the need to make such a payment, prior to the date by which payment on the credit facility must be made.

Preferably, the facilitator computer reconciles entries recorded on the credit statement against payments made on behalf of the first and/or second purchaser, as appropriate.

Preferably, the credit facility of the first purchaser and/or the credit facility of the second purchaser is a credit card facility.

More preferably, the credit card facility has an interest free period and/or loyalty scheme associated therewith.

### BRIEF DESCRIPTION OF THE DRAWINGS

FIG. 1 is a schematic representation of a first embodiment of the present invention.

FIG. 2 is a schematic representation of a second embodiment of the present invention.

FIG. 3 is a schematic representation of a third embodiment of the present invention.

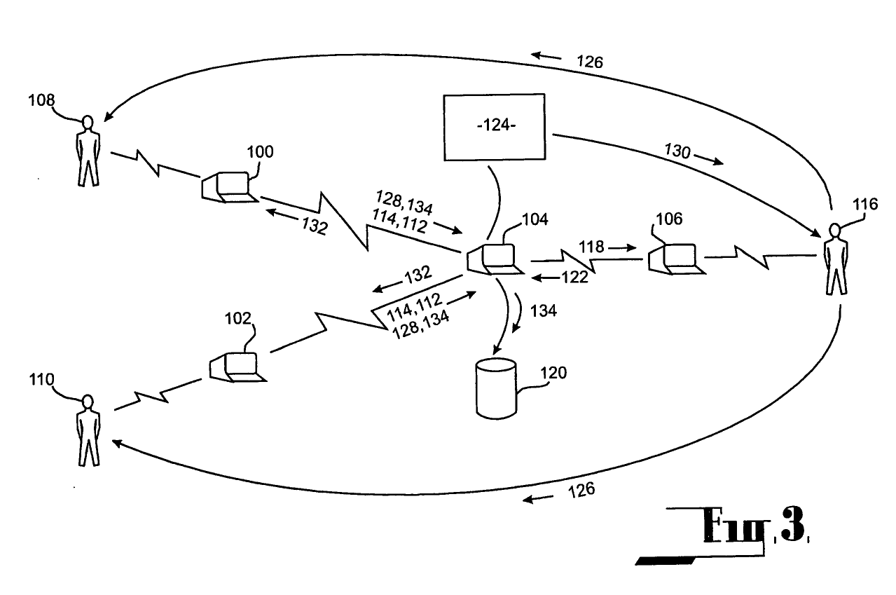

FIG. 4 is a schematic representation of a fourth embodiment of the present invention.

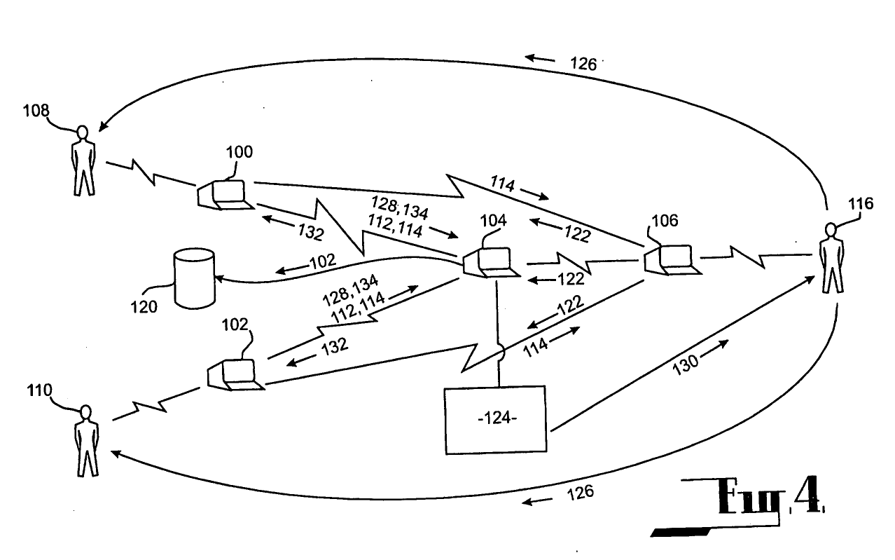

### BEST MODE(S) FOR CARRYING OUT THE INVENTION

A first embodiment of the present invention will now be described, by way of example only. The embodiment is aimed at facilitating the efficient payment for goods and/or services ordered on behalf of a first purchaser 10 and a second purchaser 12. It should be appreciated that the scope of the present invention is not to be limited by the discussion of the embodiment. For example, the present invention may involve any number of purchasers and suppliers.

In this embodiment, the first purchaser 10 and second purchaser 12 each have an established credit facility 14 with a financial institution 16, such as a bank. The financial institution 16 used by the first purchaser 10 may be different to the financial institution 16 used by the second purchaser 12.

The credit facilities 14 used by both the first and second purchaser 10, 12 have associated therewith an interest free period and a loyalty scheme. The loyalty scheme operates such that benefits are accrued through use of the associated credit facility.

The first purchaser 10 and the second purchaser 12 communicate with a facilitator 18. The first purchaser 10 and the second purchaser 12, respectively, place orders 20 for goods and/or services with the facilitator 18 and, optionally, the name of the supplier 22 from whom the goods and/or services are to be obtained. The facilitator 18 consolidates the orders 20.

If the first and second purchaser 10, 12 have stated in their order 20 the name of the supplier 22 from whom the goods and/or services are to be obtained, the facilitator 18 places the consolidated order 24 with that supplier 22 and negotiates the terms of supply. These terms include discounts on the basis of the quantity of the order 24 placed and may include discounts based on the timing of payment.

If the first and second purchaser 10, 12 do not state the name of the supplier 22 from whom the goods and/or services should be obtained, the facilitator 18 conducts enquiries with a number of suppliers 22 as to their terms of supply of the goods and/or services. Again, these terms include discounts based on the timing of payment and may include discounts on the basis of the quantity of the order placed. In an alternative embodiment, these enquiries may have been performed prior to placement of the orders 20 by the first and second purchaser 10, 12. In this alternate embodiment, details of the terms of supply for each supplier 22 are recorded by the facilitator 18 for future reference.

After conducting such enquiries, the facilitator 18 places the consolidated order 24 with the supplier 22 who offers the most favourable terms of supply (which terms may be amended by further negotiation).

Upon placement of the consolidated order 24, the supplier 22 sends an invoice 26 to the facilitator 24. A copy of the invoice 26 is sent to the first and second purchaser 10, 12 along with the goods and/or services that make up the consolidated order 24.

At some stage prior to this step, the first purchaser 10 attends to all necessary steps as set by its financial institution 16 to authorise the facilitator 18 to act on the credit facility 14 the first purchaser 10 has with that financial institution 16. Similarly, the second purchaser 12 attends to all necessary steps as set by its financial institution 16 to authorise the facilitator 18 to act on the credit facility 14 the second purchaser 12 has with that financial institution 16.

At roughly the same time as the supplier 22 sends an invoice 26 to the facilitator 18, the facilitator 18 draws on the first purchasers credit facility 14 and the second purchaser's credit facility 14. The money drawn from these credit facilities 14 in then placed in a trust account 28 associated with the facilitator 18. The amount drawn from the first purchaser's credit facility 14 and the second purchaser's credit facility 14 is proportional to the value of the goods and/or services ordered by the first purchaser 10 or second purchaser 12, as appropriate, when compared to the total value of the consolidated order 24.

By having the facilitator 18 draw on the first purchaser's 10 and second purchaser's 12 respective credit facilities 14, the credit facility 14 is “used” and thus provides benefits to the first purchaser 10 and second purchaser 12 through the associated loyalty scheme.

Upon receipt of the goods and/or services 30 by the first purchaser 10 and second purchaser 12 from the supplier 22, it is the responsibility of the first purchaser 10 and second purchaser 12, respectively, to promptly send a signed copy of the suppliers invoice 26 to the facilitator 18. Once received by the supplier 18, the signed copy of the supplier's invoice 26 acts as the facilitator's 18 authority to pay the supplier 22 and the facilitator 18 transfers monies 32 from the trust account 28 to the supplier 22 in accordance with the negotiated terms of supply. The facilitator 18 will not pay the supplier 22 until the signed invoice 26 is received. It is therefore in the best interests of the first and second purchasers 10, 12 to promptly provide a signed copy of the supplier's invoice 26 to the facilitator 18 as a failure to do so may result in withdrawal of any discount offered on the basis of timing of payment.

A portion of any discount offered by the supplier 22 as part of the negotiated terms of supply may then be passed on to the first and second purchaser 10,12, in the form of a rebate 34, if not already done so. The facilitator 18 may also retain a portion of the discount.

The facilitator 18 also charges the first and second purchaser 10, 12 a fee for facilitating the purchase order.

It is noted that the financial institutions 16 that provide credit facilities, such as credit cards, may issue statements 36 of transactions conducted in respect of the credit facility 14 to the first and second purchaser 10, 12 (as appropriate). Such statements, typically, indicate the dates by which payment must be made before interest accrues and, accordingly, upon receipt of the statement 36 the first and/or second purchaser (as appropriate) 10, 12 forwards the statement to the facilitator 18. The facilitator 18 then, at its option, performs a reconciliation on the statement 36 comparing entries recorded thereon against details of payments made by it on behalf of the first and/or second purchaser 10,12. The facilitator 18 also records the date by which payment must be made before interest accrues. In this manner, as an optional aspect of the embodiment presently described, the facilitator 18 may send one or more reminders 38 to the first and/or second purchaser 10, 12 (as appropriate) prior to this date.

In a second, alternate, embodiment of the present invention, where like numerals reference like parts, the first and second purchasers 10, 12 place orders 20 for goods and/or services directly with the supplier 22. Upon receipt of an invoice 26 for the goods and/or services purchased from the supplier 22, the first and second purchaser 10, 12, as appropriate, signs the invoice and forwards this to the facilitator 18. The provision of a signed copy of invoice 26 to the facilitator 18 provides authority to the facilitator 18 to pay the invoice 26. Upon receipt of a signed invoice 26, the facilitator 18 initiates a draw-down on the first or second purchaser's credit facility 14, as appropriate. The amount of money drawn-down from the credit facility 14 is equal to the amount of the supplier's 22 invoice 26 and the facilitator's 18 fee for facilitating the purchase order. The money drawn from both the first or second purchaser's credit facility is thereafter consolidated into a trust or other account of the facilitator 18.

Also upon receipt of a signed invoice, the facilitator 18 notes the date of issue of the signed invoice 26 and notes the date when the invoice 26 is to be paid. The date for payment is determined by the business rules of the facilitator 18 and does not necessarily coincide with the date for payment set by the supplier 22. In the arrangement contemplated, the date for payment is 7 days from the date of issue of the signed invoice 26. The facilitator 18 then proceeds to pay the invoice 26 on the determined date.

For these reasons, it is important that the first and second purchaser 10, 12 sign each invoice 26 received from a supplier 22 and forward it to the facilitator 18 as soon as possible.

At any stage within this process, the facilitator 18 may negotiate terms of supply with the supplier 22, particular focus being placed on obtaining a discount or rebate for payment of the supplier's 22 invoices 26 in accordance with the facilitator's business rules. If a discount for prompt payment is negotiated, the facilitator 18 undertakes to pay the discounted amount of the invoice on the determined date for payment. The difference between this discounted amount and the amount drawn-down from the first or second purchaser's 10, 12 credit facility is then split with half of the difference being provided as a rebate to the first or second purchaser 10, 12, as appropriate, and the remainder being retained by the facilitator 18.

If a rebate for prompt payment is negotiated, the facilitator 18 undertakes to pay the full amount of the invoice on the determined date for payment. Upon receipt of the rebate from the supplier 22 for prompt payment, half of the rebate amount is returned to the first or second purchaser 10, 12, as appropriate, the remainder being retained by the facilitator 18.

Other ancillary functions, such as setting up authorisation to draw-down on the first and second purchaser's 10, 12 credit facilities 14 and reconciliation, are also performed in the same manner as described in respect of the first embodiment. Further, the environment within which the second embodiment operates is identical to that of the first embodiment.

In a third embodiment of the present invention, there is a system for managing payment for goods and/or services.

The system involves a first purchasing computer 100, a second purchasing computer 102, a facilitator computer 104 and a supplier computer 106. The first purchasing computer 100 and the second purchasing computer 102 may be the same computer.

Each computer is of standard configuration as is well known in the art. Furthermore, the first purchasing computer 100 and second purchasing computer 102 are in data communication with the facilitator computer 104. The facilitator computer 104 is in data communication with the supplier computer 106. In the embodiment being described the means of data communication is through the Internet, however, other methods, such as direct connection, may be employed.

Each computer accesses the Internet through a web browser.

The first purchasing computer 100 and second purchasing computer 102 are, respectively, associated with a first purchaser 108 and a second purchaser 110. The first purchaser 108, using the web browser of the first purchasing computer 100, provides details of their credit facility 112 to the facilitator computer 104. The second purchaser 110, using the web browser of the second purchasing computer 102, provides details of their credit facility 112 to the facilitator computer 104.

In this embodiment, the credit facility 112 is a credit card, such as those offered under the trade marks AMERICAN EXPRESS, VISA, MASTERCARD or DINERS CLUB. Furthermore, both the first purchaser 108 and the second purchaser 110 have attended to all necessary steps as set by their respective financial institution to authorise the facilitator computer 104 to act on the credit card. In alternative embodiments (not shown), the facilitator computer 104 may be authorised to act on a credit facility 112 in such a manner that the facilitator computer 104 must access the computer systems of the financial institution providing such credit facility 112 in order to perform the necessary fund transfer transactions. In such a situation, the facilitator computer 104 can be configured to be in data communication with the computer systems of the financial institution in the same manner as the facilitator computer 104 is configured to be in data communication with the other computers mentioned above and processing as would be known to the person skilled in the art to effect such transactions would also be included.

Using the web browser of the first purchasing computer 100, the first purchaser 108 sends an order 114 for goods and/or services to the facilitator computer 104 and, optionally, the name of the supplier 116 from whom the goods and/or services are to be obtained. Using the web browser of the second purchasing computer 102, the second purchaser 110 sends an order for goods and/or services to the facilitator computer 104 and, optionally, the name of the supplier 116 from whom the goods and/or services are to be obtained. The facilitator computer 104 then consolidates the orders 114.

If the first and second purchaser 108, 110 have stated in their order the name of the supplier 116 from whom the goods and/or services should be obtained, the facilitator computer 104 sends the consolidated order 118 to the supplier computer 106 associated with that supplier 116. Terms of supply of the goods and/or services specified in the consolidated order 118 are then negotiated. This may be an automatic process between the supplier computer 106 and the facilitator computer 104 or may be a manual action. Details of the terms of supply are then recorded, either automatically or manually, in a database 120 connected to the facilitator computer 104.

If the first and second purchaser 108, 110 have not stated in their order the name of the supplier 116 from whom the goods and/or services should be obtained, the facilitator computer 104 polls a number of supplier computers 106 for information as to the terms of supply of the goods and/or services specified in the consolidated order 118. Again, this may be an automatic or manual process. After completing the poll, the facilitator computer 104 sends the consolidated order 118 to the supplier computer 106 offering the most favourable terms of supply.

As an optional step, the terms of supply offered by the most favourable supplier may be the subject of further negotiation. Again, this may be an automatic process between the facilitator computer 104 and the supplier computer 106 or may be a manual process.

Details of the terms of supply are then recorded, either automatically or manually, in a database 120 connected to the facilitator computer 104.

Regardless of how the terms of supply are achieved, the details recorded in the database 120 connected to the facilitator computer should include:
A unique identifier assigned to the consolidated order 118;
Unique identifiers assigned to the orders 114 received from the first purchasing computer 100 and the second purchasing computer 102;
The amount to be charged for the provision of the goods and/or services specified in the consolidated order 118;
Details of any discount offered by the supplier 116; and
The deadline by which payment for the provision of the goods and/or services specified in the consolidated order 118 is to be made.

Upon receipt of an order from the facilitator computer 104, the supplier computer 106 issues an electronic invoice 122 to the facilitator computer 104.

The facilitator computer 104 then draws on the first purchaser's credit card and the second purchaser's credit card. The money drawn from these credit facilities is then transferred to a trust account 124 linked to the facilitator computer 104. The amount drawn from the first purchaser's credit card and the second purchaser's credit card is proportional to the value of the goods and/or services ordered by the first purchaser 108 or second purchaser 110, as appropriate, when compared to the total value of the consolidated order 118.

Upon receipt of the goods and/or services 126 by the first purchaser 108 and second purchaser 110 from the supplier 116, it is the responsibility of the first purchaser 108 and second purchaser 110, respectively, to promptly send a signed copy of the supplier's invoice 128 for recording with the facilitator computer 104. Once recorded with the facilitator computer 104, the signed copy of the supplier's invoice 128 acts as the facilitator computer's 104 authority to transfers monies 130 from the trust account 124 to the supplier 116 in accordance with the negotiated terms of supply (as recorded in the database 120 connected to the facilitator computer 104). The facilitator computer 104 will not pay the supplier 116 until the signed copy of the supplier's invoice 128 is recorded with the facilitator computer 104.

A portion of any discount offered by the supplier 116 as part of the negotiated terms of supply is passed on to the first and second purchaser 108, 110. The facilitator computer 104 may also retain a portion of the discount in its own bank accounts.

The facilitator computer 104 may also charge a fee to the credit cards of the first and second purchaser 108, 110 for facilitating the purchase order. This may be done on an as used basis or periodically.

Optionally, the facilitator computer 104 may send one or more electronic reminders 132, such as an e-mail reminder, to the first purchasing computer 100 or second purchasing computer 102, reminding the first or second purchaser 108, 110 (as appropriate) of the date by which payment must be made on their credit facility to avoid interest. To facilitate this action, the first purchaser and/or second purchaser 108, 110 (as appropriate) must forward their credit card statement 134 for recording with the facilitator computer 104. The facilitator computer 104 then records pertinent details of the credit card statement 134, such as the final date for payment prior to interest accruing, and stores this in the database 120. The facilitator computer 104 may also automatically undertake a reconciliation of entries recorded on the credit card statement 134 against details of payments made by the facilitator computer 104 on behalf of the first and/or second purchaser 108, 110.

In yet a fourth embodiment of the present invention, being a variant of the third embodiment, the first purchasing computer 100 and second purchasing computer 102 are in data communication with the supplier computer 106. Upon receipt of an invoice 26 for the goods and/or services purchaser from the supplier 22, the first and second purchaser 10, 12, as appropriate, notifies the facilitator computer 104 of the details of the invoice 26 (separately providing a signed copy of the invoice to the facilitator 18 as authority to pay the invoice).

Upon receipt of the notice of the details of the invoice 26, the facilitator computer 104 initiates a draw-down on the first or second purchaser's credit facility, as appropriate. The amount of money drawn-down from the credit facility 14 is equal to the amount of the supplier's 22 invoice 26 and the facilitator's 18 fee for facilitating the purchase order. The facilitator computer 104 then arranges for the money drawn from both the first or second purchaser's credit facility to be consolidated into an electronic trust or other account of the facilitator 18.

The facilitator computer 104 also notes the date of issue of the invoice 26 as recorded in the details of the invoice 26 and enters into a reminder system the date when the invoice 25 is to be paid. The date for payment is determined by the business rules stored in the facilitator computer 104 and does not necessarily coincide with the date for payment set by the supplier 22. In the arrangement contemplated, the date for payment is set for 7 days from the date of issue of the invoice (provided that the facilitator 18 records that a signed copy of the invoice has been received in the meantime). The facilitator computer 104 then organises for the invoice 26 to be electronically paid on the determined date.

At any stage, the facilitator computer 104 may negotiate terms of supply with the supplier computer 106, particular focus being placed on obtaining a discount or rebate for payment of the supplier's 22 invoices 26 in accordance with the business rules stored in the facilitator computer 104. If a discount for prompt payment is negotiated, the facilitator computer organises for electronic payment of the discounted amount of the invoice on the determined date for payment. The difference between this discounted amount and the amount drawn-down from the first or second purchaser's 10, 12 credit facility is then split with half of the difference being rebated to the first or second purchaser 10, 12, as appropriate, and the reminder being retained by the facilitator 18.

If a rebate for prompt payment is negotiated, the facilitator computer 104 undertakes to pay the full amount of the invoice on the determined date for payment. Upon receipt of the rebate from the supplier computer 106 for prompt payment, half of the rebate amount is returned to the first or second purchaser 10, 12, as appropriate, the remainder being retained by the facilitator 18.

Other ancillary functions, such as setting up authorisation to draw-down on the first and second purchaser's 10, 12 credit facilities 14 and reconciliation, are also performed in the same manner as described in respect of the third embodiment. Further, the environment within which the fourth embodiment operates is identical to that of the third embodiment.

1. A client-driven method of effecting payment for goods and/or services to be performed by a single entity, the method comprising the steps of:
agreeing with a supplier terms of supply for the supply of goods and/or services;
receiving details of an order for goods and/or services from a first purchaser placed with the supplier;
receiving details of an order for goods and/or services from a second purchaser placed with the supplier;
drawing on a credit facility of the first purchaser and a credit facility of the second purchaser; and
paying the supplier for supplying the goods and/or services ordered by the first purchaser and second purchaser in accordance with the terms of supply using money drawn from the respective credit facilities of the first purchaser and second purchaser.

2. A method according to claim 1 where the step of agreeing with the supplier the terms of supply includes agreeing with the supplier on a discount and/or rebate for payment of the invoice within a predetermined period.

3. A method according to claim 2 where the predetermined period is 7 days.

4. A method according to claim 1 where:
the amount drawn from the credit facility of the first purchaser is equal to the amount of the order placed by the first purchaser and a predetermined fee for facilitating payment; and/or
the amount drawn from the credit facility of the second purchaser is equal to the amount of the order placed by the second purchaser and the predetermined fee for facilitating payment.

5. A method according to claim 1 comprising the further steps of:
accepting an authorization from the first purchaser to draw on a credit facility of the first purchaser on behalf of the first purchaser; and/or
accepting an authorization from the second purchaser to draw on a credit facility of the second purchaser on behalf of the second purchaser.

6. A method according to claim 1 comprising the further step of consolidating the funds drawn from the credit facility of the first purchaser and the credit facility of the second purchaser.

7. A method according to claim 1 comprising the further steps of:
issuing a rebate to the first purchaser, the rebate equating to a predetermined portion of the total of any discount and/or rebate offered by the supplier as part of the terms of supply; and/or
issuing a rebate to the second purchaser, the rebate equating to a predetermined portion of the total of any discount and/or rebate offered by the supplier as part of the terms of supply.

8. A method according to claim 1 comprising the further steps of:
receiving from the first purchaser and/or second purchaser a credit statement;
recording the date by which a payment on the credit facility must be made as indicated by the credit statement; and
reminding the first purchaser and/or second purchaser, as appropriate, of the need to make such a payment, prior to the date by which payment on the credit facility must be made

9. A method according to claim 8 comprising the further step of reconciling entries recorded on the credit statement against payments made on behalf of the first and/or second purchaser, as appropriate.

10. A method according to claim 1 wherein the credit facility of the first purchaser and/or the credit facility of the second purchaser is a credit card facility.

11. A method according to claim 10 wherein the credit card facility has an interest free period and/or loyalty scheme associated therewith.

12. A client-driven system of managing payment for goods and/or services comprising:
a first purchaser using a first purchasing computer in data communication with a facilitator computer;
a second purchaser using a second purchasing computer in data communication with the facilitator computer; and
a supplier using a supplier computer in data communication with the facilitator computer;
wherein the facilitator computer:
agrees with the supplier computer as to the terms of supply for the supply of goods and/or services;
receives details of an order placed with the supplier for goods and/or services sent by the first purchasing computer;
receives details of an order placed with the supplier for goods and/or services sent by the second purchasing computer;
draws on a credit facility of the first purchaser and a credit facility of the second purchaser; and
pays the supplier for supplying the goods and/or services ordered by the first purchaser and second purchaser in accordance with the terms of supply using money drawn from the respective credit facilities of the first purchaser and second purchaser.

13. A system according to claim 12 where, in agreeing with the supplier computer as to the terms of supply, the facilitator computer agrees with the supplier computer on a discount and/or rebate for payment of the invoice within a predetermined period.

14. A system according to claim 13 where the predetermined period is 7 days.

15. A system according to claim 12 where the facilitator computer also:
draws from the credit facility of the first purchaser an amount equal to that of the order placed by the first purchaser and a predetermined fee for facilitating payment; and/or
draws from the credit facility of the second purchaser an amount equal to that of the order placed by the second purchaser and the predetermined fee for facilitating payment.

16. A system according to claim 12 where the facilitator computer also:
accepts an authorization from the first purchaser, through the first purchasing computer, to draw on a credit facility of the first purchaser on behalf of the first purchaser; and/or
accepts an authorization from the second purchaser, through the second purchasing computer, to draw on a credit facility of the second purchaser on behalf of the second purchaser.

17. A system according to claim 12 where the facilitator computer consolidates funds drawn from the credit facility of the first purchaser and the credit facility of the second purchaser.

18. A system according to claim 12 where the facilitator computer:
issues a rebate to the first purchaser, the rebate equating to a predetermined portion of the total of any discount and/or rebate offered by the supplier as part of the terms of supply; and/or
issuing a rebate to the second purchaser, the rebate equating to a predetermined portion of the total of any discount and/or rebate offered by the supplier as part of the terms of supply.

19. A system according to claim 12 where the facilitator computer:
receives from the first purchaser and/or second purchaser, through their respective purchasing computer, an electronic copy of a credit statement;
records the date by which a payment on the credit facility must be made as indicated by the credit statement; and
reminds the first purchaser and/or second purchaser, as appropriate and through their purchasing computer, of the need to make such a payment, prior to the date by which payment on the credit facility must be made.

20. A system according to claim 19 where the facilitator computer reconciles entries recorded on the credit statement against payments made on behalf of the first and/or second purchaser, as appropriate.

21. A system according to claim 12 where the credit facility of the first purchaser and/or the credit facility of the second purchaser is a credit card facility.

22. A system according to claim 21 where the credit card facility has an interest free period and/or loyalty scheme associated therewith.

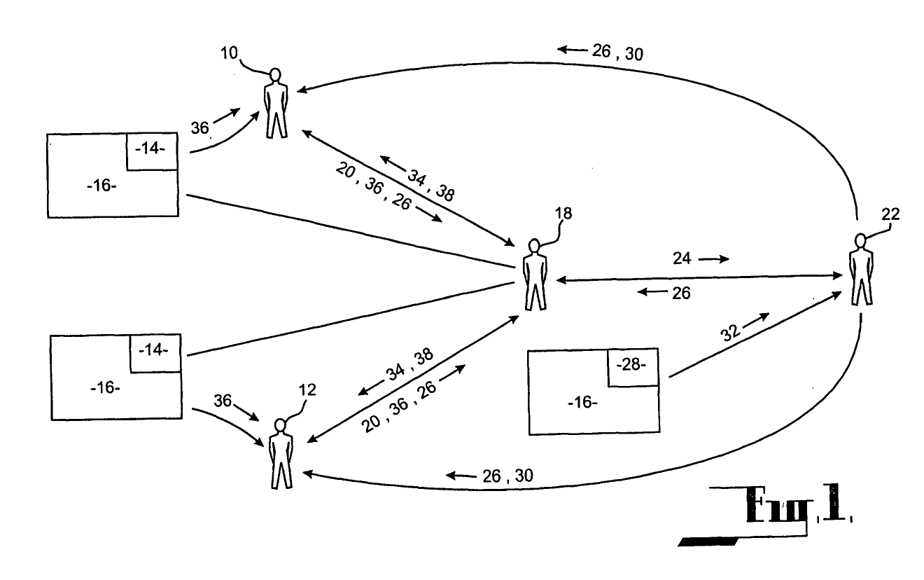

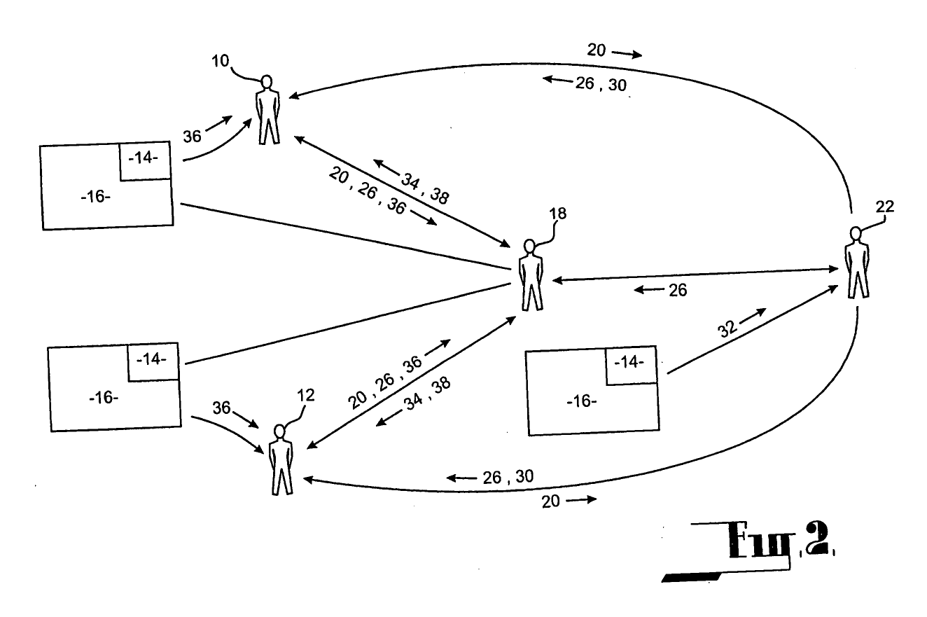

23. A method substantially as described herein with reference to FIG. 1 or 2.

24. A system substantially as described herein with reference to FIG. 1 or 2.
